(19) United States
(12) Patent Application Publication
(10) Pub. No.: US 2010/0032174 A1
(43) Pub. Date: Feb. 11, 2010

(54) Gas-Foam Fire-Extinguishing Product, Process for Preparing the Same, Use Thereof and Fire-Extinguishing System Using the Same

(75) Inventors: Kanghui Xu, Hangzhou (CN); Ping Gu, Hangzhou (CN); Junyang Wang, Hangzhou (CN); Jing Yang, Hangzhou (CN); Lejun Shou, Hangzhou (CN); Shenliang Li, Hangzhou (CN); Suhong Min, Hangzhou (CN)

Correspondence Address: THE WEBB LAW FIRM, P.C., 700 KOPPERS BUILDING, 436 SEVENTH AVENUE, PITTSBURGH, PA, 15219, US

(73) Assignee: Hangzhou New Epoch Fire Protection Science and Technology Co., Ltd., Hangzhou (CN)

(21) Appl. No.: 12/512,502

(22) Filed: Jul. 30, 2009

(30) Foreign Application Priority Data
Jun. 22, 2008 (CN) 200810120340.2

(51) Int. Cl. A62C 3/00

(52) U.S. Cl. 169/43; 169/9

(57) ABSTRACT

The present invention relates to a gas-foam fire-extinguishing product consisting of a clean gas fire-extinguishing agent and a foam fire-extinguishing agent, a process for preparing the product, use of the product and a fire-extinguishing system using the product. According to the present invention, the clean gas fire-extinguishing agent is used as a foaming agent for the foam fire-extinguishing agent and is contained in the generated foams. The present invention solved a problem in the prior art for a long time that the combustible liquids with Slow boiling point are difficult to be fire-extinguished.

### FIELD OF THE INVENTION

The present invention belongs to the field for preparing and applying fire-extinguishing products and fire-extinguishing systems. Specifically, the present invention relates to a gas-foam fire-extinguishing product consisting of a clean gas fire-extinguishing agent and a foam fire-extinguishing agent, a process for preparing the product, use of the product and a fire-extinguishing system using the product.

### BACKGROUND OF THE INVENTION

Clean gas fire-extinguishing agents and foam fire-extinguishing agents are widely used in the prior art.

I, Clean Gas Fire-Extinguishing Agent (HFC-227ea).

HFC-227ea is a clean gas fire-extinguishing agent with the chemical name of heptafluoropropane and chemical formula of CF3CHFCF3, which is in conformity with NFPA-200 specified by National Fire Protection Association (NFPA) and characterized as a nonconductive, volatile or gaseous fire-extinguishing agent without residue during use. Furthermore, HFC-227ea is an environmental friendly nontoxic clean gas fire-extinguishing agent with short residence time in nature and high fire-extinguishing efficiency, thus being suitable for protection of areas with resident staffs.

HFC-227ea as a clean gas fire-extinguishing agent functions on a mechanism that when being used in a total flooding systematic environment, HFC-227ea is capable of fire-extinguishing by promptly and effectively removing heat via physical variations and chemical reactions in combination; specifically, HFC-227ea can promptly reduce the flame temperature by evaporation and liberate radicals by chemical reactions, thereby blocking the chain reactions of the combustion.

Automatic fire-extinguishing systems using HFC-227ea as a clean gas fire-extinguishing agent have the following characteristics.

1). High speed, high efficiency and highly proactive. Specifically, such automatic fire-extinguishing systems usually can extinguish fires completely in a period of ten seconds; regarding the protection areas, the designed concentration of HFC-227ea can be very low such as 7 wt % only; also, HFC-227ea can be stored as liquid and can evaporate promptly to extinguish fires, thus being highly proactive for fire-extinguishing,

2). Clean. Specifically, the automatic fire-extinguishing systems using HFC-227ea as a clean gas fire-extinguishing agent are very suitable for protecting electrical equipments, magnetic media, file archives or precious articles and valuable equipments, because HFC-227ea is harmless to the protected materials and has no residue after fire-extinguishing so that the routine affairs within the protection areas would not be interrupted;

3). Safe. HFC-227ea is nontoxic and will not cause any problems with the respiratory system, thus being known internationally as a fire-extinguishing agent that is harmless to the human body; also, due to small liberating pressure and being nontoxic, the automatic fire-extinguishing systems using HFC-227ea as a clean gas fire-extinguishing agent are very suitable for the protection of areas with resident staffs;

4). Environmental friendly. HFC-227ea has no damage to the atmospheric ozone layer and resides in the atmosphere for a period of 31-42 years only, thus not being listed in the plan for out of use by international environmental protection organizations;

5). Economical. For being in conformity with the current environmental protection regulations, the automatic fire-extinguishing systems using HFC-227ea as a clean gas fire-extinguishing agent would not be replaced afterwards with costs wasted; and the designs of the automatic fire-extinguishing systems can utilize combinative distributions with integrated storage systems, thus being more economical and effective for fire-preventions; also, the automatic fire-extinguishing systems using HFC-227ea as a clean gas fire-extinguishing agent have small volumes due to the small number of gas cylinders, thus the chambers for gas cylinders can be saved or even eliminated;

6). Established technologies. HFC-227ea as a clean gas fire-extinguishing agent has been put into practice over ten years already. There are thousands of examples for successful applications around the world, and the specifications for designing and engineering the same have been established internationally.

The automatic fire-extinguishing systems using HFC-227ea as a clean gas fire-extinguishing agent consist of two parts, i.e. the gas pipeline network and the automatic control system, both of which are independent from and cooperative with each other to get a fire extinguished in operation.

Although HFC-227ea as a clean gas fire-extinguishing agent has many advantages as above-mentioned, its greatest disadvantage is that it can not extinguish the open space fires and the deepseated fires effectively due to its diffusibility as a gas fire-extinguishing agent.

II, Foam Fire-Extinguishing Agent

The foam generated by foam fire-extinguishing agents is bubble clusters with small volumes and surfaces being surrounded by liquids, and has a density of 0.001-0.5 g/cm³, which is much lower than that of the usual combustible liquids, so that the foam can float over the liquid surface as a protection cover to block the combusting materials from the air to get the fire-smothering; also, the foam has an ability to adhere onto solids, thus being a bit effective for extinguishing the fire of solids. However, because the foam generated by foam fire-extinguishing agents contains air inside at high temperatures the air inside of the foam would promote the combustion of the hot materials, rather than fire-extinguishing the same.

Carbon dioxide as a fire-extinguishing agent is filled in the extinguisher as liquid carbon dioxide. When opening the valve of the extinguisher, the liquid carbon dioxide would rise to the nozzle via a siphon tube and evaporate promptly with volume being increased to about 500 times and a large amount of heat being adsorbed, thus the temperature within the spraying tube is decreased dramatically, and when the temperature is decreased to −78.5° C., a part of the carbon dioxide condenses into solid snow flakes, which, when being sprayed onto the combusting materials, can decrease the temperature of the combusting materials, isolate the same from the air as well as reduce the oxygen concentration of the air, thus get the fire extinguished. Carbon dioxide generally functions by smothering, thus it hardly extinguishes the smoldering materials, even worse when the air is with an oxygen concentration of more than 12 vol % in the combusting area; Furthermore, carbon dioxide neither can extinguish the fires caused by metals such as lithium, sodium, potassium, magnesium, aluminium, stibium, titanium, cadmium, platinum, plutonium and the like as well as the oxides of these metals, nor the fires caused by materials comprising oxygen per se such as nitrocellulose, celluloid, powder and the like.

Regarding the combustible materials with a low boiling point, due to their low ignition point, clean gas fire-extinguishing agents can not extinguish the same thoroughly for being limited by environmental conditions and being diffused easily, and regarding the combustible gases with low boiling point, clean gas fire-extinguishing agents can not function by chain break anyway.

And, the foam fire-extinguishing agents in the prior art use air as foaming agent, i.e. the oxygen-comprising air is contained in the foams. When being used for fire-extinguishing, particularly at extremely high temperature of the combusting materials, the air contained in the foams not only hardly can get fire smothered by blocking the combusting materials from the air, but also would promote the combustion of the materials conversely. Such a result is extremely not desired for fire-extinguishing the combustible materials with a low boiling point, particularly the combustible liquids with a low boiling point.

### SUMMARY OF THE INVENTION

Regarding the problem in the prior art that the combustible materials with a low boiling point, particularly the combustible liquids with a low boiling point that are difficult to be fire-extinguished, the present invention provides a gas-foam fire-extinguishing product with dual fire-extinguishing functions, and the present invention also provides a process for preparing the product, use of the product and a fire-extinguishing system using the product.

Specifically, the present invention provides a gas-foam fire-extinguishing product consisting of a clean gas fire-extinguishing agent and a foam fire-extinguishing agent, wherein the clean gas fire-extinguishing agent is used as a foaming agent for the foam fire-extinguishing agent and is contained in the generated foams.

Furthermore, the present invention also provides a process for preparing a gas-foam fire-extinguishing product consisting of a clean gas fire-extinguishing agent and a foam fire-extinguishing agent, wherein the clean gas fire-extinguishing agent is used as a foaming agent for the foam fire-extinguishing agent, and wherein the clean gas fire-extinguishing agent is mixed instantaneously with the foam fire-extinguishing agent so that it is contained in the generated foams.

Furthermore, the present invention also provides the use of a gas-foam fire-extinguishing product consisting of a clean gas fire-extinguishing agent and a foam fire-extinguishing agent for fire-extinguishing the combustible materials with a low boiling point, particularly the combustible liquids with a low boiling point, wherein the clean gas fire-extinguishing agent is used as a foaming agent for the foam fire-extinguishing agent and is contained in the generated foams.

Furthermore, the present invention also provides a fire-extinguishing system using a clean gas fire-extinguishing agent and a foam fire-extinguishing agent in combination, wherein the clean gas fire-extinguishing agent is used as a foaming agent for the foam fire-extinguishing agent and is contained in the generated foams, and said system comprises a means for supplying the foam fire-extinguishing agent, a means for supplying the clean gas fire-extinguishing agent, a gas-foam mixer and a foam generator, wherein the means for supplying the foam fire-extinguishing agent is communicated with the gas-foam mixer via line, the means for supplying the clean gas fire-extinguishing agent is communicated with the gas-foam mixer via line, and the outlet of the gas-foam mixer is communicated with the foam generator via line.

According to the present invention, the clean gas fire-extinguishing agent and the foam fire-extinguishing agent are used in a ratio of 10:90-90:10, preferably of 20:80-80:20, more preferably of 30:70-70:30, still more preferably of 40:60-60:40, and most preferably of 50:50 by volume.

According to the present invention, the clean gas fire-extinguishing agent can be any clean gas fire-extinguishing agent known in the art, specifically, the clean gas fire-extinguishing agent can be selected from the group consisting of trifluoroiodomethane, perfluoropropane, perfluorobutane, hexafluoroethane, dichlorodifluoroethane, chlorodifluoromethane, chlorotetrafluoroethane, pentafluoroethane, heptafluoropropane, trifluoromethane, hexafluoropropane, argon, nitrogen, carbon dioxide and mixture of argon, nitrogen and carbon dioxide.

According to the present invention, the foam fire-extinguishing agent can be any foam fire-extinguishing agent known in the art; specifically, the foam fire-extinguishing agent can be selected from the group consisting of protein foam, fluoroprotein foam, alcohol type fluoroprotein foam, film-forming fluoroprotein foam, aqueous film-forming foam, aqueous alcohol type film-forming foam and synthetic foam.

All the above-mentioned clean gas fire-extinguishing agents and foam fire-extinguishing agents can be prepared by those processes in the prior art or can be commercially available, thus not described in detail herein.

According to the present invention, the foam fire-extinguishing agent and the clean gas fire-extinguishing agent are used in combination, wherein the clean gas fire-extinguishing agent is used as a foaming agent for the foam fire-extinguishing agent and is contained in the generated foams. Thus, the inventive gas-foam fire-extinguishing product has the functions both of the foam fire-extinguishing agent and the clean gas fire-extinguishing agent, that is to say, not only the function of covering and smothering by the foam fire-extinguishing agent, but also the function of highly effective chain break by the clean gas fire-extinguishing agent. Due to that, the inventive gas-foam fire-extinguishing product generates foams with the clean gas fire-extinguishing agent, which having fire-extinguishing function, rather than the air being contained therein, when being used for fire-extinguishing, particularly at extremely high temperatures, the generated foams not only show good function of covering and smothering by the foam fire-extinguishing agent, but also the clean gas fire-extinguishing agent contained in the foams can get chain broken by blocking the combusting materials from the air completely, so that the case with the foam fire-extinguishing agents in the prior art that the air contained in the foams may promote the combustion can be avoided totally, thus completed fire-smothering can be achieved. Thus, the inventive gas-foam fire-extinguishing product is very suitable for effectively fire-extinguishing the combustible materials with a low boiling point, particularly the combustible liquids with a low boiling point.

According to the present invention, the fire-extinguishing system uses the clean gas fire-extinguishing agent and the foam fire-extinguishing agent in combination, wherein the clean gas fire-extinguishing agent is used as a foaming agent for the foam fire-extinguishing agent and is contained in the generated foams, wherein the clean gas fire-extinguishing agent and the foam fire-extinguishing agent are provided proportionally to the gas-foam mixer, and the operating pressure of the system is maintained at higher than the saturated vapor pressure of the clean gas fire-extinguishing agent so that the clean gas fire-extinguishing agent and the foam fire-extinguishing agent flow in lines as liquids and arrive at the foam generator finally to generate foams with the clean gas fire-extinguishing agent contained therein, i.e. the generated foams containing no oxygen therein. And the generated foams can extinguish fires by covering the surface of the combusting materials.

According to the present invention, with the fire-extinguishing system, the means for supplying the foam fire-extinguishing agent, the means for supplying the clean gas fire-extinguishing agent, the gas-foam mixer and the foam generator can be any suitable means in the prior art, e.g. the gas-foam mixer can be the means generating foams mechanically or by chemical reactions, thus not described in detail herein.

Thus, by using the clean gas fire-extinguishing agent and the foam fire-extinguishing agent in combination, specifically using the clean gas fire-extinguishing agent as a foaming agent for the foam fire-extinguishing agent, the present invention combines the fire-extinguishing functions of the two fire-extinguishing agents, and avoids successfully the disadvantages, which may be present with each fire-extinguishing agent being used separately, thereby getting fire extinguished effectively.

### BRIEF DESCRIPTION OF THE DRAWING

FIG. 1 is a schematic drawing showing the inventive fire-extinguishing system using a clean gas fire-extinguishing agent and a foam fire-extinguishing agent in combination.

### DETAILED DESCRIPTION OF THE INVENTION

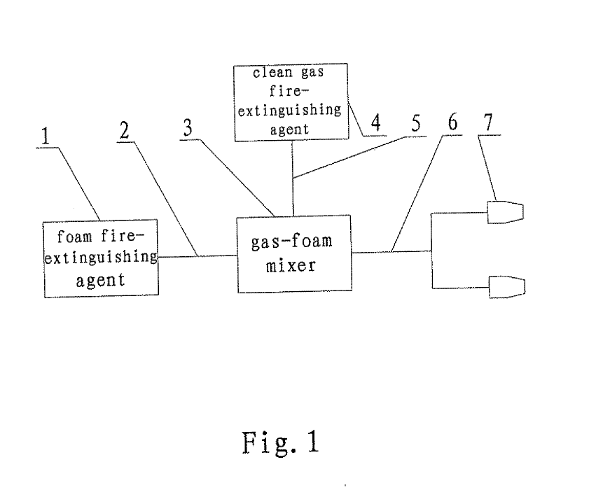

Now the present invention is further illustrated in details referring to FIG. 1. According to the present invention, the fire-extinguishing system uses the clean gas fire-extinguishing agent and the foam fire-extinguishing agent in combination, and the clean gas fire-extinguishing agent is used as a foaming agent for the foam fire-extinguishing agent and is contained in the generated foams. As shown in FIG. 1, the present fire-extinguishing system comprises a means for supplying the foam fire-extinguishing agent 1, a means for supplying the clean gas fire-extinguishing agent 4, a gas-foam mixer 3 and a foam generator 7, wherein the means for supplying the foam fire-extinguishing agent 1 is communicated with the gas-foam mixer 3 via line 2, the means for supplying the clean gas fire-extinguishing agent 4 is communicated with the gas-foam mixer 3 via line 5, and the outlet of the gas-foam mixer 3 is communicated with the foam generator 7 via line 6.

When being operated, the foam fire-extinguishing agent and the clean gas fire-extinguishing agent are provided proportionally to the gas-foam mixer 3 through the means for supplying the foam fire-extinguishing agent 1 and the means for supplying the clean gas fire-extinguishing agent 4 respectively, and the operating pressure of the total system is maintained at higher than the saturated vapor pressure of the clean gas fire-extinguishing agent so that the clean gas fire-extinguishing agent and the foam fire-extinguishing agent flow in lines as liquids and arrive at the foam generator 7 finally to generate foams with the clean gas fire-extinguishing agent contained therein, and the generated foams can extinguish fires by covering the surface of combusting materials.

The following examples are provided to further illustrate the invention in detail. It should be noted that all the examples are provided for illustrating the invention only rather than to limit the same and any combinations, additions or modifications without departing from the inventive spirit should be covered by the protective scope of the present invention.

### EXAMPLES

Using the extinguishing system shown in FIG. 1, the following examples according to the present invention were carried out respectively.

### Example 1

Using trifluoromethane as the clean gas fire-extinguishing agent and fluoroprotein foam as the foam fire-extinguishing agent, both of them were supplied to the gas-foam mixer in a ratio of 40:60 by volume and used to extinguish the combusting gasoline. The result was that the combusting gasoline was fire-extinguished promptly, i.e. the effect was excellent.

### Example 2

Using hexafluoropropane as the clean gas fire-extinguishing agent and aqueous alcohol type film-forming foam as the foam fire-extinguishing agent, both of them were supplied to the gas-foam mixer in a ratio of 50:50 by volume and used to extinguish the combusting gasoline. The result was that the combusting gasoline was fire-extinguished promptly, i.e. the effect was excellent.

1-19. (canceled)

20. A gas-foam fire-extinguishing product consisting of a clean gas fire-extinguishing agent and a foam fire-extinguishing agent.

21. The gas-foam fire-extinguishing product of claim 20, wherein the clean gas fire-extinguishing agent is used as a foaming agent for the foam fire-extinguishing agent and the clean gas fire-extinguishing agent is contained in the generated foams.

22. The gas-foam fire-extinguishing product of claim 20, wherein the clean gas fire-extinguishing agent and the foam fire-extinguishing agent are used in a ratio of 10:90-90:10, preferably of 20:80-80:20, more preferably of 30:70-70:30, still more preferably of 40:60-60:40, and most preferably of 50:50 by volume.

23. The gas-foam fire-extinguishing product of claim 20, wherein the clean gas fire-extinguishing agent is selected from the group consisting of trifluoroiodomethane, perfluoropropane, perfluorobutane, hexafluoroethane, dichlorodifluoroethane, chlorodifluoromethane, chlorotetrafluoroethane, pentafluoroethane, heptafluoropropane, trifluoromethane, hexafluoropropane, argon, nitrogen, carbon dioxide and mixture of argon, nitrogen and carbon dioxide.

24. The gas-foam fire-extinguishing product of claim 20, wherein the foam fire-extinguishing agent is selected from the group consisting of protein foam, fluoroprotein foam, alcohol type fluoroprotein foam, film-forming fluoroprotein foam, aqueous film-forming foam, aqueous alcohol type film-forming foam and synthetic foam.

25. A process for preparing a gas-foam fire-extinguishing product consisting of a clean gas fire-extinguishing agent and a foam fire-extinguishing agent, wherein the clean gas fire-extinguishing agent is used as a foaming agent for the foam fire-extinguishing agent, and wherein the clean gas fire-extinguishing agent is mixed instantaneously with the foam fire-extinguishing agent and is contained in the generated foams.

26. The process of claim 25, wherein the clean gas fire-extinguishing agent and the foam fire-extinguishing agent are used in a ratio of 10:90-90:10, preferably of 20:80-80:20, more preferably of 30:70-70:30, still more preferably of 40:60-60:40, and most preferably of 50:50 by volume.

27. The process of claim 25, wherein the clean gas fire-extinguishing agent is selected from the group consisting of trifluoroiodomethane, perfluoropropane, perfluorobutane, hexafluoroethane, dichlorodifluoroethane, chlorodifluoromethane, chlorotetrafluoroethane, pentafluoroethane, heptafluoropropane, trifluoromethane, hexafluoropropane, argon, nitrogen, carbon dioxide and mixture of argon, nitrogen and carbon dioxide.

28. The process of claim 25, wherein the foam fire-extinguishing agent is selected from the group consisting of protein foam, fluoroprotein foam, alcohol type fluoroprotein foam, film-forming fluoroprotein foam, aqueous film-forming foam, aqueous alcohol type film-forming foam and synthetic foam.

29. A method for fire-extinguishing combustible materials with a low boiling point, comprising the step of applying a gas-foam fire-extinguishing product consisting of a clean gas fire-extinguishing agent and a foam fire-extinguishing agent to the combustible materials.

30. The method of claim 29, wherein the clean gas fire-extinguishing agent is used as a foaming agent for the foam fire-extinguishing agent and the clean gas fire-extinguishing agent is contained in the generated foams.

31. The method of claim 29, wherein the clean gas fire-extinguishing agent and the foam fire-extinguishing agent are used in a ratio of 10:90-90:10, preferably of 20:80-80:20, more preferably of 30:70-70:30, still more preferably of 40:60-60:40, and most preferably of 50:50 by volume.

32. The method of claim 29, wherein the clean gas fire-extinguishing agent is selected from the group consisting of trifluoroiodomethane, perfluoropropane, perfluorobutane, hexafluoroethane, dichlorodifluoroethane, chlorodifluoromethane, chlorotetrafluoroethane, pentafluoroethane, heptafluoropropane, trifluoromethane, hexafluoropropane, argon, nitrogen, carbon dioxide and mixture of argon, nitrogen and carbon dioxide.

33. The method of claim 29, wherein the foam fire-extinguishing agent is selected from the group consisting of protein foam, fluoroprotein foam, alcohol type fluoroprotein foam, film-forming fluoroprotein foam, aqueous film-forming foam, aqueous alcohol type film-forming foam and synthetic foam.

34. A fire-extinguishing system using a clean gas fire-extinguishing agent and a foam fire-extinguishing agent in combination, wherein the clean gas fire-extinguishing agent is used as a foaming agent for the foam fire-extinguishing agent and the clean gas fire-extinguishing agent is contained in the generated foams, and said system comprises a means for supplying the foam fire-extinguishing agent, a means for supplying the clean gas fire-extinguishing agent, a gas-foam mixer and a foam generator, wherein the means for supplying the foam fire-extinguishing agent is communicated with the gas-foam mixer via line, the means for supplying the clean gas fire-extinguishing agent is communicated with the gas-foam mixer via line, and the outlet of the gas-foam mixer is communicated with the foam generator via line.

35. The fire-extinguishing system of claim 34, wherein the clean gas fire-extinguishing agent and the foam fire-extinguishing agent are used in a ratio of 10:90-90:10, preferably of 20:80-80:20, more preferably of 30:70-70:30, still more preferably of 40:60-60:40, and most preferably of 50:50 by volume.

36. The fire-extinguishing system of claim 34, wherein the clean gas fire-extinguishing agent is selected from the group consisting of trifluoroiodomethane, perfluoropropane, perfluorobutane, hexafluoroethane, dichlorodifluoroethane, chlorodifluoromethane, chlorotetrafluoroethane, pentafluoroethane, heptafluoropropane, trifluoromethane, hexafluoropropane, argon, nitrogen, carbon dioxide and mixture of argon, nitrogen and carbon dioxide.

37. The fire-extinguishing system of claim 34, wherein the foam fire-extinguishing agent is selected from the group consisting of protein foam, fluoroprotein foam, alcohol type fluoroprotein foam, film-forming fluoroprotein foam, aqueous film-forming foam, aqueous alcohol type film-forming foam and synthetic foam.

38. The fire-extinguishing system of claim 34, wherein the operating pressure of the system is higher than the saturated vapor pressure of the clean gas fire-extinguishing agent so that the clean gas fire-extinguishing agent and the foam fire-extinguishing agent flow in lines as liquids.
